(19) United States
(12) Patent Application Publication
(10) Pub. No.: US 2024/0306194 A1
(43) Pub. Date: Sep. 12, 2024

(54) SECONDARY CHANNEL ACCESS

(71) Applicant: NXP USA, Inc., Austin, TX (US)

(72) Inventors: Kiseon Ryu, San Diego, CA (US); Liwen Chu, San Ramon, CA (US); Rui Cao, Sunnyvale, CA (US); Huizhao Wang, San Jose, CA (US); Hongyuan Zhang, Fremont, CA (US)

(73) Assignee: NXP USA, Inc., Austin, TX (US)

(21) Appl. No.: 18/600,545

(22) Filed: Mar. 8, 2024

Related U.S. Application Data
(60) Provisional application No. 63/489,513, filed on Mar. 10, 2023.

(51) Int. Cl. H04W 74/08

(52) U.S. Cl. CPC H04W 74/08

(57) ABSTRACT

In an IEEE 802.11 wireless system, a wireless STA is configured to access a secondary channel by receiving an inter-BSS PPDU which identifies a transmission channel bandwidth for the inter-BSS PPDU and TXOP duration, and then accessing a secondary channel which excludes the transmission channel bandwidth identified by the inter-BSS PPDU and a primary 20 MHz channel for the wireless STA device from a basic service set (BSS) operating bandwidth associated with the wireless STA device before exchanging one or more frames on the secondary channel during the TXOP duration without using the primary 20 MHz channel for the wireless STA device, and then switching back to the primary 20 MHz channel before the TXOP duration ends.

### CROSS-REFERENCE TO RELATED APPLICATION AND PRIORITY CLAIM

This application claims the benefit of U.S. Provisional Patent Application No. 63/489,513, entitled “Secondary Channel Access” filed on Mar. 10, 2023, which is incorporated by reference in its entirety as if fully set forth herein.

### BACKGROUND

### Field

The present disclosure is directed in general to communication networks. In one aspect, the present disclosure relates generally to accessing an operating bandwidth in wireless communication systems.

### Description of the Related Art

An ever-increasing number of relatively inexpensive, low power wireless data communication services, networks and devices have been made available over the past number of years, promising near wire speed transmission and reliability. Enabling technology advances in the area of wireless communications, various wireless technology standards (including for example, the IEEE Standards 802.11a/b/g, 802.11n, 802.11ac, 802.11.ax and their updates and amendments, as well as the IEEE Standard 802.11be now in the process of being adopted) have been introduced that are known to persons skilled in the art and are collectively incorporated by reference as if set forth fully herein fully. These standards specify various methods of establishing connections between wireless communication devices (e.g., access points (APs) or non-AP station STA devices) by transmitting various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). Some applications, such as high definition (HD) video surveillance applications, outdoor video sharing applications, etc., require relatively high system throughput as well as good network coverage.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 depicts identical operating bandwidths having the same frequency band for first and second AP devices operating in overlapping basic service sets.

FIG. 2 depicts identical operating bandwidths having different frequency bands for first and second AP devices operating in overlapping basic service sets.

FIG. 3 depicts different operating bandwidths having different frequency bands for first and second AP devices operating in different, overlapping basic service sets.

FIG. 4 depicts a block diagram of a wireless communications system with secondary channel access capabilities in accordance with selected embodiments of the present disclosure.

FIG. 5 depicts a frame exchange sequence diagram between an OBSS STA device, OBSS AP device, BSS AP device, and BSS STA device which are connected and configured to perform secondary channel access operations in accordance with selected embodiments of the present disclosure.

### DETAILED DESCRIPTION

Existing 802.11 AP/STA devices within a basic service set (BSS) are blocked from accessing any portion of a specified operating bandwidth upon detecting that a portion of the operating bandwidth is busy, such as can occur when there is detection of a packet from an overlapping basic service set (OBSS). For example, in 802.11be, a busy 20 MHz primary channel prevents a STA from accessing an idle 300 MHz of remaining bandwidth. Such inefficient bandwidth utilization in 802.11 wireless networks causes more loss with increasing operating bandwidth. The existing solutions for wireless communications are extremely difficult at a practical level by virtue of the difficulty in handling increased data signaling loads between wireless communication devices while balancing requirements for overhead, processing, and timings costs.

A system, apparatus, and methodology are described for a wireless communication system where an access point (AP) and/or non-access point station (non-AP STA) device within a first Base Service Set (BSS) are configured to receive an overlapping BSS (OBSS) PPDU data frame (e.g., a non-HT duplicate PPDU, HE PPDU, EHT PPDU, UHR PPDU or RTS/CTS/Ack/BA in a non-HT PPDU) from a second BSS, where the OBSS PPDU data frame contains bandwidth information and transmission opportunity (TXOP) duration information for the second BSS. In response to the OBSS PPDU data frame, the AP and/or non-AP STA device detects a conflict with a primary 20 MHz channel within a defined operating bandwidth for the first BSS, and then accesses a secondary, non-conflicting channel within the defined operating bandwidth for the first BSS which does not conflict with the primary 20 MHZ channel. In selected embodiments, a first AP device at the first BSS detects an OBSS frame from the second BSS which conveys bandwidth information for the OBSS frame, uses the bandwidth information (alone or in combination with bandwidth configuration information) for the OBSS frame to identify the secondary, non-conflicting channel, and then transmits a MAC control frame (e.g., a multi-user request-to-send (MU-RTS) Trigger frame, an RTS frame, a buffer status report poll (BSRP) Trigger frame, etc.) to one or more non-AP STA devices in the first BSS using the secondary, non-conflicting channel so that one or more subsequent data frames may be transmitted by the first AP device to the one or more non-AP STA devices in the first BSS during a basic network allocation vector (NAV) set by the OBSS frame. In other selected embodiments, one or more of the non-AP STA devices in the first BSS may be configured to receive the OBSS frame, detect a conflict with a primary 20 MHz channel within a defined operating bandwidth for the first BSS, and then access the secondary, non-conflicting channel using the bandwidth information (alone or in combination with bandwidth configuration information) for the OBSS frame to transmit a Clear to Send (CTS) frame (or a BSR frame) back to the first AP device using the secondary, non-conflicting channel during a basic network allocation vector (NAV) set by the OBSS frame. In other selected embodiments, one or more of the non-AP STA devices in the first BSS may update a basic NAV timer based on bandwidth information indicated in a second OBSS PPDU that is received on the secondary, non-conflicting channel.

In the context of the present disclosure, it will be understood by those skilled in the art that that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

References throughout this specification to “one embodiment”, “an embodiment,” “selected embodiments,” or similar language means that a particular feature, structure, or characteristic described in connection with the indicated embodiment is included in at least one embodiment of the present disclosure. Thus, the phrases “in one embodiment”, “in an embodiment,” “selected embodiments,” and similar language throughout this specification may, but do not necessarily, all refer to the same embodiment.

With existing wireless communications standards (e.g., Wi-Fi 5 or IEEE 802.11ac), co-channel interference (CCI) situations arise between different basic service sets (BSS) which overlap with one another when AP devices in the different BSSs can hear one another. In these situations, an AP device in a first BSS is blocked from accessing any portion of a specified operating bandwidth upon detecting that a portion of the operating bandwidth is busy with serving an AP device from a second, overlapping BSS. As a result of AP devices using a “listen before talk” process when trying to connect to a network, each AP device would have to “listen” for any noise on a channel before transmitting, resulting in network congestion. In particular, if an 802.11 STA device detects that the primary 20 MHz channel is busy, the existing standard specifies that the 802.11 STA device does not transmit on any of the portion of the operating bandwidth, even when those portions are idle. Such inefficient bandwidth utilization in 802.11 causes more loss with increasing operating bandwidth. For example, with the IEEE 802.11be being developed to propose a 320 MHz operating bandwidth, a busy 20 MHz primary channel prevents the 802.11 STA device from accessing an idle 300 MHz of remaining bandwidth.

As proposed by an IEEE submission entitled “Non-Primary Channel Utilization” (IEEE document number IEEE 802.11-23/0034rl (February 2023), the problem of inefficient bandwidth usage can be alleviated by allowing a STA device to transmit on a subset of channels that are a part of its operating bandwidth if they are idle and provided other qualifying conditions are met while considering the inherent dependence of 802.11 STA devices on a primary 20 MHZ channel. For example, OBSS conflict avoidance solutions have been proposed wherein a receiving STA device which supports preamble/packet detection on one channel at a time can sequentially switch to one or more alternative channels after determining the relevance and duration of the OBSS occupancy of the primary channel. In this solution, the transmitting and receiving STA devices must agree on a sequence or order of trying different channels (e.g., Set1, Set2, etc.) for data exchange without there being any anchor channels. As an initial step, the transmitting STA device performs a clear channel assessment (CCA) on the first channel set (e.g., Set1) which includes the primary 20 MHz channel, and transmits on those channels if the enhanced distributed channel access (EDCA) completes (i.e., the transmitting STA device wins channel access on the primary 20 MHz channel and zero or more channels of Set1). However, if no channel from the first channel set is available and the primary 20 MHz channel is occupied by OBSS, the transmitting STA device attempts to transmit on the second channel set (e.g., Set2) only for the duration for which the primary 20 MHz channel is busy, and this process continues until all channels are tested for availability, at which point control returns to the first channel set (e.g., Set1) upon expiration of the duration determined by CCA (e.g., NAV or PPDU length) on the primary 20 MHz channel.

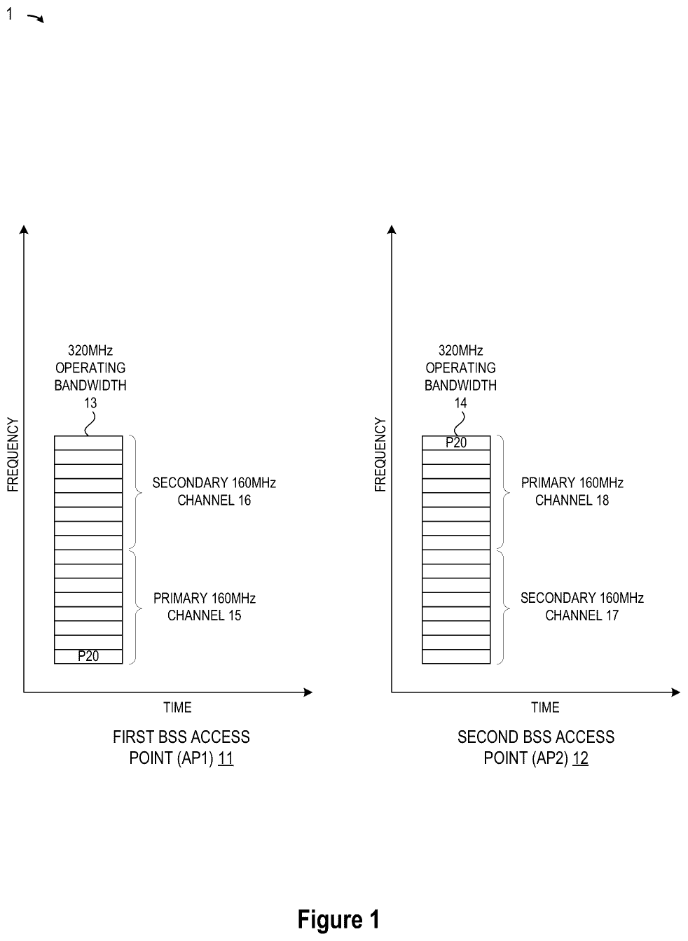

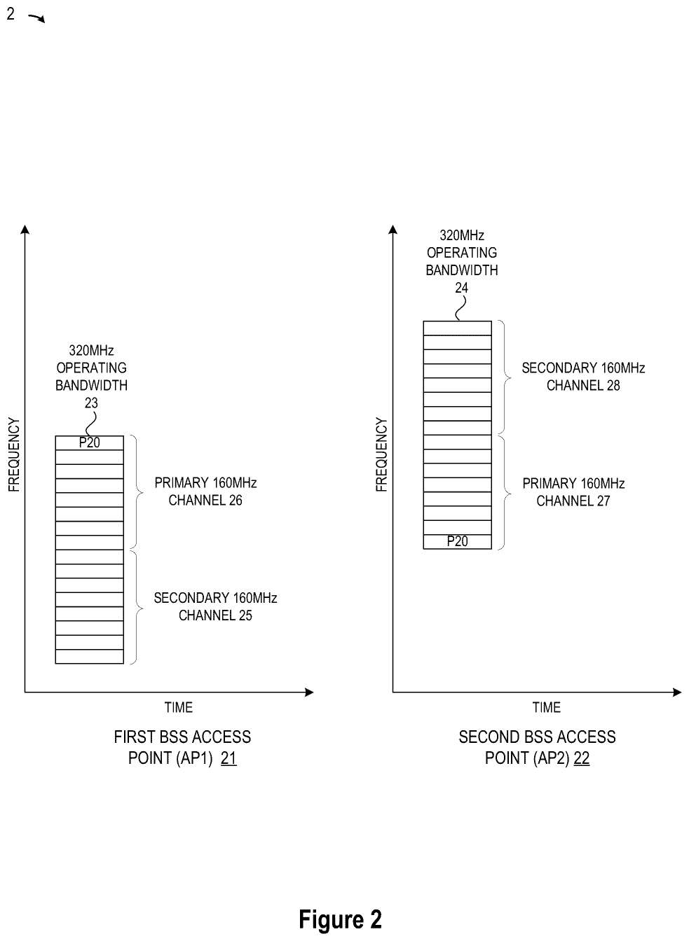

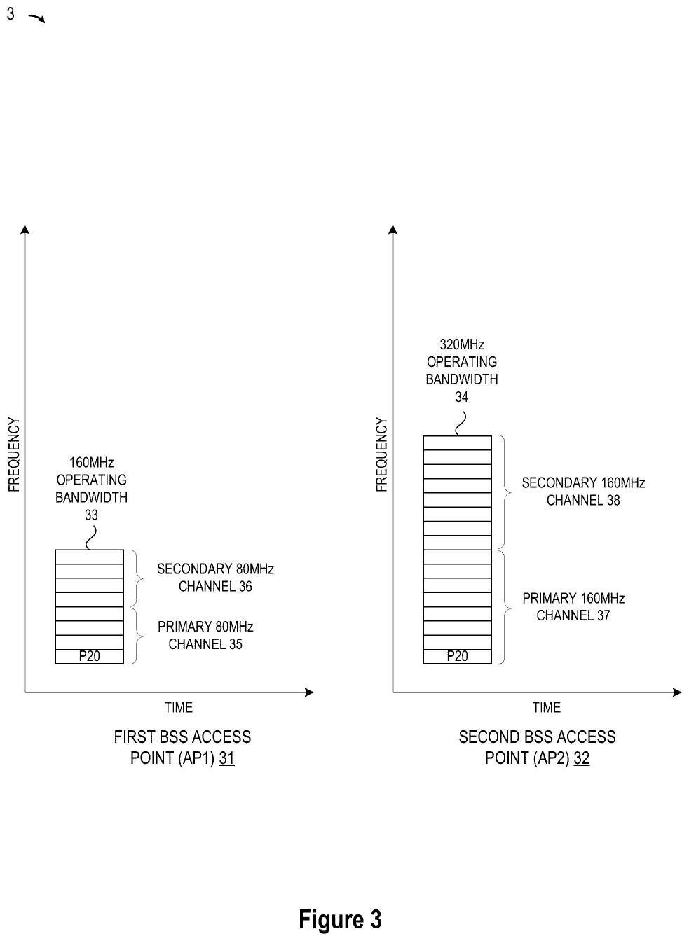

To provide a contextual understanding for selected embodiments of the present disclosure, reference is now made to FIGS. 1-3 which depict operating bandwidths for first and second AP devices operating in overlapping basic service sets. In particular, FIG. 1 depicts identical overlapping 320 MHz operating bandwidths 1 having the same frequency band for first and second AP devices operating in overlapping basic service sets. In addition, FIG. 2 depicts identical, partially overlapping 320 MHz operating bandwidths 2 having different frequency bands for first and second AP devices operating in overlapping basic service sets. In addition, FIG. 3 depicts a 160 MHz operating bandwidth and a 320 MHz operating bandwidth 3, respectively, for first and second AP devices operating in different, overlapping basic service sets. To simplify the present disclosure, FIGS. 1-3 will be used to illustrate both the challenges with conventional 802.11 signaling approaches which prevent secondary channel access from occurring, and also the presently disclosed approach for accessing secondary channels in a wireless communication system.

According to the existing 802.11 standard, an AP or non-AP STA device with a non-zero basic NAV timer value is not able to access the entire operating bandwidth of the BSS until the basic NAV timer becomes zero, regardless of the bandwidth of the OBSS frame because the STA device does not consider the bandwidth or configuration information of a detected OBSS frame. In particular, the existing 802.11 standard allows the first and second BSS AP devices 11, 12 to have different primary channels and different channel configurations that are not known to one another.

For example and as illustrated in FIG. 1, the first BSS AP device (API) 11 has a 320 MHz operating bandwidth 13 with the primary 20 MHz channel located in the lowest 20 MHz channel. This bandwidth and configuration information is known to the STA devices associated with or belonging to the first BSS, but the AP and STA devices in the second BSS are not aware of the first BSS's bandwidth information or primary 20 MHz channel location. Similarly, the second BSS AP device (AP2) 12 has an identical, overlapping 320 MHz operating bandwidth 14 with the primary 20 MHz channel located in the highest 20 MHz channel. This bandwidth and configuration information is known to the STA devices associated with or belonging to the second BSS, but the AP and STA devices in the first BSS are not aware of the second BSS's bandwidth information or primary 20 MHz channel location. As a result, when the first and second BSS AP devices 11, 12 are positioned to have overlapping operating bandwidths 13, 14, a BSS frame transmitted by the second BSS AP device (AP2) 12 on its 320 MHz operating bandwidth 14 is received as an OBSS frame on the primary 20 MHz channel P20 for the first BSS AP device (AP1) 11, prompting the first BSS AP device (API) 11 to set a basic NAV timer to a non-zero value which prevents the first BSS AP 11 from using any of its 320 MHz operating bandwidth 13 to provide secondary channel access when there appears to be a conflict with the primary 20 MHz channel location for the first BSS AP device 11, even though part of the 320 MHz operating bandwidth 13 (e.g., the primary 160 MHz channel 15) might be available, depending on the bandwidth of the received OBSS frame.

In another example illustrated in FIG. 2, the first BSS AP device (AP1) 21 has a 320 MHz operating bandwidth 23 with the primary 20 MHz channel located in the highest 20 MHz channel, and this is known to the STA devices associated with or belonging to the first BSS. Similarly, the second BSS AP device (AP2) 22 has an identical, nonoverlapping 320 MHz operating bandwidth 24 with the primary 20 MHz channel located in the lowest 20 MHz channel, and this is known to the STA devices associated with or belonging to the second BSS. Since the AP and STA devices in the first BSS are not aware of the second BSS's bandwidth information or primary 20 MHz channel location, a BSS frame transmitted by the second BSS AP device (AP2) 22 on its 320 MHz operating bandwidth 24 is received as an OBSS frame on the primary 20 MHz channel P20 for the first BSS AP device (AP1) 21, prompting the first BSS AP device (AP1) 21 to set a basic NAV timer to a non-zero value which prevents the first BSS AP 21 from using any of its 320 MHz operating bandwidth 23 to provide secondary channel access when there appears to be a conflict with the primary 20 MHz channel location for the first BSS AP device 21, even though part of the 320 MHz operating bandwidth 23 (e.g., the secondary 160 MHz channel 25) might be available, depending on the bandwidth of the received OBSS frame.

In another example illustrated in FIG. 3, the first BSS AP device (AP1) 31 has a 160 MHz operating bandwidth 33 with the primary 20 MHz channel located in the lowest 20 MHZ channel, and this is known to the STA devices associated with or belonging to the first BSS. Similarly, the second BSS AP device (AP2) 32 has an identical, nonoverlapping 320 MHz operating bandwidth 34 with the primary 20 MHz channel located in the lowest 20 MHz channel, and this is known to the STA devices associated with or belonging to the second BSS. Since the AP and STA devices in the second BSS are not aware of the first BSS's bandwidth information or primary 20 MHz channel location, a BSS frame transmitted by the first BSS AP device (AP12) 31 on its 160 MHz operating bandwidth 33 is received as an OBSS frame on the primary 20 MHz channel P20 for the second BSS AP device (AP2) 32, prompting the second BSS AP device (AP2) 32 to set a basic NAV timer to a non-zero value which prevents the second BSS AP 32 from using any of its 320 MHz operating bandwidth 34 to provide secondary channel access when there appears to be a conflict with the primary 20 MHz channel location for the second BSS AP device 32, even though part of the 320 MHz operating bandwidth 34 (e.g., the secondary 160 MHz channel 38) might be available, depending on the bandwidth of the received OBSS frame.

To address these limitations from existing 802.11 wireless communications systems and signaling protocol solutions and others known to those skilled in the art, there is disclosed herein a wireless communication station device, system, apparatus, and methodology for using bandwidth information (alone or in combination with channel configuration information) for a received OBSS frame to selectively control NAV operation and to provide for secondary channel access between STA devices in a first BSS. In particular, AP and non-AP STA devices in the first BSS are configured to extract and use bandwidth information/channel configuration information from a received OBSS frame to specify a secondary, non-conflicting channel for the first BSS which does not conflict with the primary 20 MHz channel of a second, overlapping BSS.

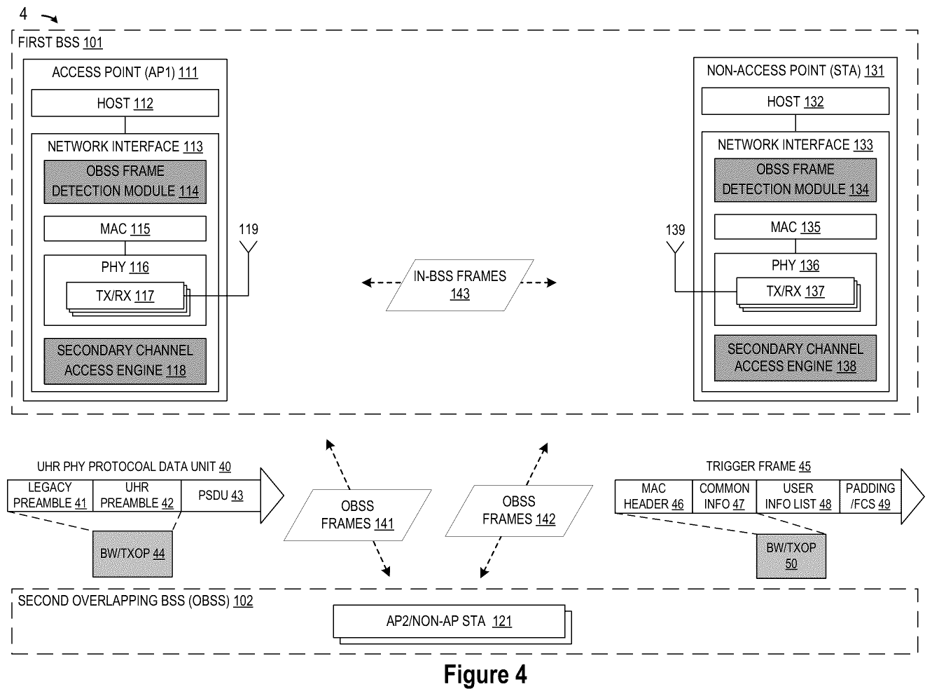

To provide additional details for an improved understanding of selected embodiments of the present disclosure, reference is now made to FIG. 4 which depicts a block diagram of a wireless communications system 4 in which a plurality of STA devices 111, 131 which are connected and synchronized for 802.11 communications in a first basic service set (BSS) 101 which uses a primary 20 MHz channel to exchange data frames 143 over defined frequency channels in a specified operating bandwidth for the first BSS 101. For example, the first BSS 101 may include a first access point device (AP1) 111 and one or more non-access point station (STA) devices 131. The depicted wireless communications system 4 also includes a second basic service set 102 formed with a plurality of STA devices 121, such as a second access point device (AP2) and one or more non-access point STA devices, which are also connected and synchronized for 802.11 communications using a primary 20 MHz channel for the second BSS 102.

In the first BSS 101, the first access point (API) device 111 may operate as a transmitter station device which transmits one or more data frames 143 to a receiving non-AP STA device 131. In other embodiments, the direction of data frame transmission may be reversed from the transmitting non-AP STA device 131 to the API device 111. As depicted, the API device 111 includes a host processor 112 coupled to a network interface 113. In selected embodiments, the network interface 113 includes one or more integrated circuits (IC) devices configured to operate a local area network (LAN) protocol. To this end, the network interface 113 may include a medium access control (MAC) processor 115 and a physical layer (PHY) processor 116. In selected embodiments, the MAC processor 115 is implemented as an IEEE 802.11bn MAC processor 115, and the PHY processor 116 is implemented as an IEEE 802. 11bn PHY processor 116. The PHY processor 116 includes a plurality of transceivers 117 which are coupled to a plurality of antennas 119 (only one antenna is shown for simplicity). Although three transceivers 117 and three antennas 19 may be used in selected embodiments, the AP1 device 111 may use any suitable number of transceivers 117 and antennas 119. In addition, the AP1 111 may have more antennas 19 than transceivers 17, in which case antenna switching techniques are used to switch the antennas 19 between the transceivers 17. In selected embodiments, the MAC processor 115 is implemented with one or more integrated circuit (IC) devices, and the PHY processor 116 is implemented on one or more additional IC devices. In other embodiments, at least a portion of the MAC processor 115 and at least a portion of the PHY processor 116 are implemented on a single IC device. In various embodiments, the MAC processor 115 and the PHY processor 116 are configured to operate according to at least a first communication protocol (e.g., 802.11bn). In other embodiments, the MAC processor 115 and the PHY processor 116 are also configured to operate according to one or more additional communication protocols. Using the communication protocol(s), the API device 111 is operative to create a first BSS 101 in which the API device 111 may wirelessly communicate with one or more STA devices (e.g., 131) located within the first BSS 101.

At least one of the non-AP STA devices 131 is configured to operate at least according to the first communication protocol. To this end, the non-AP STA device 131 includes a host processor 132 coupled to a network interface 133. In selected embodiments, the network interface 133 includes one or more IC devices configured to operate as discussed below. For example, the depicted network interface 133 may include a MAC processor 135 and a PHY processor 136. In selected embodiments, the MAC processor 135 is implemented as an 802.11bn MAC processor 135, and the PHY processor 136 is implemented as an 802.11bn PHY processor 136. The PHY processor 136 includes a plurality of transceivers 137 coupled to a plurality of antennas 139. Although three transceivers 137 and three antennas 139 may be used in selected embodiments, the non-AP STA device 131 may include any suitable number of transceivers 137 and antennas 139. In addition, the non-AP STA device 131 may include more antennas 139 than transceivers 137, in which case antenna switching techniques are used. In selected embodiments, the MAC processor 135 is implemented on at least a first IC device, and the PHY processor 136 is implemented on at least a second IC device. In other embodiment, at least a portion of the MAC processor 135 and at least a portion of the PHY processor 136 are implemented on a single IC device.

As will be appreciated, the second access point device (AP2) and any non-access point STA devices in the second BSS 102 may have a structure that is the same as or similar to the API device 111 or non-AP STA device 131, though there can be structural differences.

When the first BSS 101 and second BSS 102 are positioned to have overlapping coverage areas, data frames 141, 142 sent by the second BSS 102 can create inter-BSS interference, and are therefore referred to as OBSS frames from the perspective of the first BSS 101. In particular and as described above, if a STA device 111, 131 of the first BSS 101 detects an OBSS data frame 141, 142 from the second BSS 102 which signals that the primary 20 MHz channel for the first BSS 101 is busy, then each STA device 111, 131 would be prevented, under existing 802.11 standards, from transmitting on any portion of the operating bandwidth for the first BSS 101.

To prevent a received OBSS frame 141, 142 from interfering with the transmission of data frames 142 in the first BSS 101, the wireless STA devices 111, 131 of the first BSS 101 are respectively configured with OBSS Frame Detection modules 114, 134 and secondary channel access engines 118, 138 which operate to detect OBSS frames 141, 142 received from the second overlapping BSS 102 which conflict with the primary 20 MHz channel at the first BSS 101, and to selectively access a secondary channel for communications at the first BSS 101 by extracting bandwidth information/channel configuration information from a received OBSS frame 141, 142 for use in selecting and accessing the secondary channel and setting a local NAV timer to control the secondary channel access.

In particular and as depicted in FIG. 4, the OBSS frames 141, 142 may be transmitted using any suitable OBSS PPDU format by the second overlapping BSS 102 to signal bandwidth (BW) information and transmission opportunity (TXOP) duration information 44, 50 which the OBSS frame detection modules 114, 134 use to detect a conflict with a primary 20 MHz channel within a defined operating bandwidth for the second overlapping BSS 102, and which the secondary channel access engines 118, 138 then use to access a secondary, non-conflicting channel within the defined operating bandwidth for the second overlapping BSS 102 which does not conflict with the primary 20 MHz channel for the first BSS 101. For example, the suitable OBSS PPDU formats may include an UHR PHY Protocol Data Unit/Packet 40 which has a legacy preamble portion 41, an UHR preamble portion 42, and an (optional) PHY Service Data Unit (PSDU) portion 43. The contents of the legacy and UHR preamble portions 41, 42 are known to those skilled in the art, and will not be detailed other than to note that they may be modified as disclosed herein to enable secondary channel access functionality. Another suitable OBSS PPDU formats may include a Trigger Frame 45 which has a MAC header portion 46, a common info portion 47, a user info list 48, and additional padding/FCS portion 49. The contents of the Trigger Frame 45 are known to those skilled in the art, and will not be detailed other than to note that they may be modified as disclosed herein to enable secondary channel access functionality.

As set forth more fully hereinbelow, the API device 111 and non-AP STA device 131 can detect the bandwidth BW and the TXOP in the OBSS PPDUs 141, 142, depending on the type of OBSS PPDUs sent from the second overlapping BSS 102. For example, if the detected PPDU 141, 142 is an HE PPDU, EHT PPDU, or UHR PPDU, then a SIG field of the PHY header in the detected PPDU 141, 142 contains the Bandwidth field and the TXOP field. Alternatively, if the detected PPDU 141, 142 is a non-HT (duplicate) PPDU and it is an RTS/CTS/Ack/BA frame, then the bandwidth information can be indicated in the SERVICE field of the detected PPDU 141, 142, and the TXOP length information is indicated in the Duration field of the MAC header. Alternatively, if the detected PPDU 141, 142 is a non-HT (duplicate) PPDU and it is a Trigger frame, then the TXOP length information is indicated in the Duration field of the MAC header and the bandwidth information is indicated in the UL BW subfield of the Common Info field of the Trigger frame.

In accordance with selected embodiments of the present disclosure wherein any secondary channel access in the first BSS 101 is based on bandwidth information contained in a received OBSS frame 141, 142, a first case is now described with reference to an example scenario where the first API device 111 and a second AP2 device 121 have identical, overlapping operating bandwidths (e.g., 320 MHz) having the same frequency band, such as depicted in FIG. 1. In this scenario, the first API device 111 monitors only its own primary 20 MHz channel (P20) when assessing whether to access a secondary channel. In particular, each OBSS Frame Detection module 114, 134 is operatively configured to detect from the OBSS frame (e.g., 141) that the primary 20 MHz channel of the first BSS 101 is busy only when 320 MHz channel is busy due to transmission of the OBSS frame 141 by the second AP2 device. In addition, each secondary channel access engine 118, 138 is operatively configured to determine that there is no case for accessing a secondary channel in this scenario. As will be appreciated, a similar operation occurs at the second BSS 102 when the second AP2/non-AP STA devices 121 detects an OBSS frame from the first BSS 101.

In another embodiment for basing secondary channel access on bandwidth information contained in a received OBSS frame, a second case is now described with reference to an example scenario where the first API device 111 and a second AP2 device 121 have identical, partially overlapping operating bandwidths (e.g., 320 MHz) located in different frequency bands, such as depicted in FIG. 2. In this scenario, the first API device 111 monitors only its own primary 20 MHz channel (P20) when assessing whether to access a secondary channel. In particular, each OBSS Frame Detection module 114, 134 is operatively configured to detect from the OBSS frame (e.g., 141) that the primary 20 MHz channel of the first BSS 101 is busy when the primary 160 MHz channel or 320 MHz channel is busy due to transmission of the OBSS frame 141 by the second AP2 device. In addition, each secondary channel access engine 118, 138 is operatively configured to perform secondary channel access when the received OBSS frame (e.g., 141) is transmitted a bandwidth that is equal to or wider than the amount of operating bandwidth overlap (e.g., 160 MHZ). For example, if the detected OBSS frame 141 is transmitted on the P160 MHz or 320 MHz channel, then the first API device 111 can access a secondary channel. In selected embodiments, if the OBSS Frame Detection module 114 of the first API device 111 detects that an OBSS frame 141 received on the P20 has an operating bandwidth of 320 MHz, then the secondary channel access engine 118, 138 is operatively configured to identify the secondary 160 MHz channel (S160) 25 for the first API device 111 as the secondary access channel since it is not overlapped with the secondary 160 MHz channel (S160) 28 for the second AP2 device. In addition, if the OBSS Frame Detection module 114 (134) of the first AP1 device 111 (non-AP STA device 131) detects the OBSS channel configuration of a received OBSS frame 141 (e.g., the primary 20 MHz channel is located in the lowest 20 MHz channel of the 320 MHz operating bandwidth of the OBSS frame), the secondary channel access engine 118, 138 of first API device 111 and/or the non-AP STA 131 may be operatively configured to perform secondary channel access, even when a received OBSS frame has the same operating bandwidth as the first BSS 101, provided that the OBSS channel configuration indicates that the primary 160 MHz channel (P160) 27 for the OBSS frame 141 overlaps with the primary 160 MHz channel (P160) 26 for the first API device 111. In other selected embodiments, if the OBSS Frame Detection module 114 of the first API device 111 detects that an OBSS frame 141 received on the P20 has an operating bandwidth of 160 MHZ, then the secondary channel access engine 118, 138 is operatively configured to identify the secondary 160 MHz channel (S160) 25 for the first API device 111 as the secondary access channel. As will be appreciated, a similar operation occurs at the second BSS 102 when the second AP2/non-AP STA devices 121 detects an OBSS frame from the first BSS 101.

In another embodiment for basing secondary channel access on bandwidth information contained in a received OBSS frame, a third case is now described with reference to an example scenario where the first API device 111 and a second AP2 device 121 have different overlapping operating bandwidths but the same primary 20 MHz (P20) channel location, such as depicted in FIG. 3. In this scenario, the first API device 111 monitors only its own primary 20 MHz channel (P20) when assessing whether to access a secondary channel. In particular, the OBSS Frame Detection module at each of the first API device 111 and the second AP2 device 121 can sense their primary 20 MHz channels being busy when any of APs (AP1 or AP2) access its primary channel. In addition, a secondary channel access engine (not shown) at the second AP2 device 121 is operatively configured to perform secondary channel access through the secondary 160 MHz channel (S160) 38 for the second AP2 device 121 as the secondary access channel when the first API device 111 accesses the primary 160 MHz channel (P160) 37. As will be appreciated, the first AP1 device 111 can perform secondary channel access through the secondary 80 MHz channel (S80) 36 when the second AP2 device accesses the primary 80 MHZ channel (P80) 35.

Generally speaking, there are two options for accessing the secondary channel based on bandwidth information in the OBSS frame. In the first “bandwidth” option, an AP or a non-AP STA device considers only the operating bandwidth of a received OBSS frame when accessing a secondary channel which excludes the operating bandwidth of a received OBSS frame from the primary channel, regardless of the OBSS channel configuration. In a second “bandwidth/channel configuration” option, an AP or non-AP STA device considers both the operating bandwidth and the channel configuration of the received OBSS frame when accessing a secondary channel which is the non-overlapping secondary channel portion of an operating bandwidth which does not include the primary 20 MHz channel (P20)

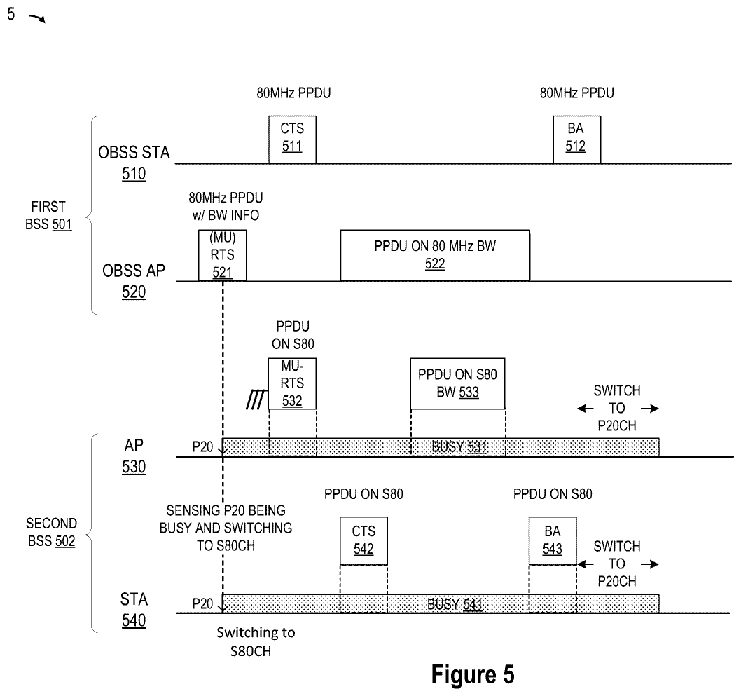

To provide additional details for an improved understanding of selected embodiments of the present disclosure, reference is now made to FIG. 5 which depicts a frame exchange sequence diagram 5 between an OBSS STA device 510, OBSS AP device 520, BSS AP device 530, and BSS STA device 540. In operation, the OBSS STA device 510 and OBSS AP device 520 are operatively connected to form a first BSS 501, and the BSS AP device 530 and BSS STA device 540 are operatively connected to form a second BSS 502.

In normal operation of the first BSS 501, the OBSS AP device 520 sends a MAC control frame 521 to protect or reserve a transmission opportunity (TXOP) for a frame exchange between the OBSS AP device 520 and OBSS STA 510. The MAC control frame 521 may take any suitable structure or form, such as a Multi-User Request to Send (MU-RTS) frame 521 to reserve the TXOP for one or more OBSS STA devices 510 in a first BSS. At a minimum, the MAC control frame 521 includes address information for the destination OBSS STA device 510 (e.g., MAC address), a TXOP duration field, and PPDU bandwidth information. In addition, the MAC control frame 521 may optionally also include bandwidth or channel configuration information specifying how the OBSS AP device 520 configures its operating BSS bandwidth (e.g., PPDU BW size, primary 20 MHz channel location, etc.). In the depicted example, the MAC control frame 521 is an 80 MHz PPDU which includes bandwidth (BW) information. To confirm protection signaling completion, the OBSS STA device 510 may be configured to send a Clear to Send (CTS) frame 511 to the OBSS AP device 520 using an 80 MHz PPDU. In response, the OBSS AP device 520 transmits a Physical layer Protocol Data Unit (PPDU) 522 to the OBSS STA device 510 using the 80 MHz bandwidth. For example, in the MU-RTS frame 521 and the CTS frame 511, the OBSS AP device 520 reserves a 5 millisecond (ms) TXOP which the OBSS AP device 520 uses for PPDU 522 transmission and acknowledgement frame 512 reception. The OBSS STA device 510 sends an acknowledgement frame (e.g., Ack, BA, or M-BA) 512 back to the OBSS AP device 520 using an 80 MHz PPDU.

As will be appreciated, the AP device 530 and STA device 540 also operate normally to exchange frame messages using a specified operating bandwidth in the second BSS 502. In normal operation, the frame exchange sequence starts when the AP device 530 uses the specified operating bandwidth to send a MAC control frame, such as an MU-RTS frame, to the STA device 540 to protect or reserve a TXOP for a frame exchange. In response, the STA device 540 sends a CTS message frame to confirm protection signaling completion to the AP device 530 which subsequently transmits a PPDU to the STA device 540 using the operating bandwidth for the second BSS 502. Upon completion of the PPDU transmission, the STA device 540 sends an acknowledgement frame (e.g., Ack, BA, or M-BA) to the AP device 530.

In situations where the first and second BSS 501, 502 are positioned to have overlapping coverage areas, interference can arise between access point devices AP 520, 530 or wireless STA devices 510, 540 which are located close together and operating on the same transmission channel that have no connection to each other. In the example of FIG. 5, the AP device 530 and STA device 540 in the second BSS 502 can receive frames from the neighboring OBSS AP device 520 and OBSS STA device 510 in the first BSS 501. Such overlapping BSS (OBSS) frames occur more frequently in broadband WLANs due to the higher bandwidths of 40 MHz, 80 MHz, 160 MHz, and 320 MHz, and to the increasing number of WLAN devices competing with each other for radio access.

To utilize wireless channel efficiently, the AP and STA devices 530, 540 in the second BSS 502 are connected and configured to selectively access a secondary channel which excludes a bandwidth of an OBSS frame received from the OBSS AP device 520. In particular, upon detecting the MAC control frame 521, each of the AP and STA devices 530, 540 are configured to detect that the primary 20 MHz channel P20 for the second BSS 502 is busy, and to then switch to a secondary channel in the operating bandwidth for the second BSS 502 which excludes the bandwidth of the received OBSS frame 521. In the depicted example, if the MAC control frame 521 is received as a (MU-)RTS frame which indicates an 80 MHz bandwidth in the UL BW field (e.g., 80 MHz non-HT Dup PPDU), then the AP and STA devices 530, 540 in the second BSS 502 are each configured to set at a basic NAV timer to a value indicated in the Duration field of the (MU-)RTS frame 521, effectively signaling that the AP and STA devices 530, 540 in the second BSS 502 are “busy” 531, 541 for the duration of the NAV timer. In addition, the AP device 530 that receives the (MU-)RTS Trigger frame 521 on the primary 20 MHz channel may access a secondary channel when transmitting MAC control frame 532, such as by transmitting the MU-RTS frame 532 (or a BSRP Trigger frame) on the secondary 80 MHz channel (S80) to a non-AP STA device 540 that supports the secondary channel access capability until the basic NAV timer set by the MAC control frame 521 (e.g., (MU-)RTS frame) becomes 0. To confirm protection signaling completion, the STA device 540 sends a CTS message frame to the AP device 530, such as by transmitting the CTS frame 542 (or a BSR frame) on the secondary 80 MHz channel (S80). In response, the AP device 530 transmits a PPDU 533 to the STA device 540 using the secondary 80 MHz channel (S80). After receiving the PPDU 533, the STA device 540 sends an acknowledgement frame (e.g., Ack, BA, or M-BA) 543 back to the AP device 530, such as by sending a PPDU using the secondary 80 MHz channel (S80), and then switches back to the primary 20 MHz channel P20 for the STA device 540. After receiving the acknowledgement frame 543 from the STA device 540, the AP device 530 switches back to the primary 20 MHz channel P20. As seen from the foregoing, the secondary channel access between the AP and STA devices 530, 540 is done within the time period of OBSS transmission (e.g., OBSS TXOP). As a result, the AP and STA devices 530, 540 performing secondary channel access shall finish their frame exchanges 532, 542, 533, 543 so that each switched to return to the primary 20 MHz channel before OBSS TXOP 531, 541 ends.

As described herein and depicted in FIG. 5, the AP device 530 may extract bandwidth information and TXOP duration information from one or more predetermined fields in the MAC control frame 521, depending on format used for the MAC control frame. For example, if the AP and STA devices 530, 540 detect an OBSS PPDU (e.g., HE/EHT/UHR PPDU) and decode its PHY header, then the AP and STA devices 530, 540 can obtain the OBSS TXOP duration and BW information of the OBSS PPDU from the HE/EHT/UHR SIG field in the PHY header, and can then switch to the secondary channel at the same time for frame exchanges during the OBSS TXOP. Alternatively, if the AP and STA devices 530, 540 receive an OBSS PPDU (e.g., RTS/CTS/Ack/BA in a non-HT PPDU), then the AP and STA devices 530, 540 can obtain the OBSS TXOP duration from the Duration field in the MAC header, and can also obtain the BW information from the SERVICE field of the non-HT PPDU. Alternatively, if the AP and STA devices 530, 540 receive an OBSS PPDU (e.g., Trigger frame), then the AP and STA devices 530, 540 can obtain the OBSS TXOP duration from the Duration field in the MAC header, and can also obtain the BW information from the UL BW subfield of the Common Info field in the Trigger frame. Then, the AP and STA devices 530, 540 can switch to the secondary channel at the same time for frame exchanges during the OBSS TXOP.

To provide additional details for an improved understanding of selected embodiments of the present disclosure, there is now described a second example embodiment of the AP and STA devices 530, 540 in the second BSS 502 being connected and configured to selectively access a secondary channel which excludes a bandwidth of an OBSS frame received from the OBSS AP device 520. In this second example embodiment, if the AP device 530 receives the MAC control frame 521, such as an EHT MU PPDU with the Bandwidth field in the U-SIG field set to “3” (to indicate 160 MHZ) and with the TXOP field set not to “UNSPECIFIED,” the AP device 530 sets a basic NAV timer to a value calculated by the value of the TXOP field. In addition, upon receiving the PHY header of the UHR (or EHT) MU PPDU on the primary 20 MHz channel, the AP device 530 may access the secondary 160 MHz channel to transmit a frame on the secondary 160 MHz channel to the non-AP STA device 530 that supports the secondary channel access capability until the basic NAV timer set by the MAC control frame 521 (e.g., RTS frame) becomes 0.

As will be appreciated, the bandwidth information of the OBSS frame (a.k.a., Inter-BSS PPDU) that is received on the primary 20 MHz channel can be used by the AP and STA devices 530, 540 to select the secondary channel using any suitable secondary channel selection scheme. In a first secondary channel selection scheme, the bandwidth information in the OBSS frame directly indicates the available secondary channel(s) without leaving any gap between the OBSS frame bandwidth and the secondary channel options. For example, when the OBSS frame (e.g., non-HT duplicate PPDU, HE PPDU, EHT PPDU, UHR PPDU) bandwidth information indicates 20 MHz, then the secondary 20/40/80/160 MHz channel is allowed for secondary channel access. And when the OBSS frame (e.g., non-HT duplicate PPDU, HE PPDU, EHT PPDU, UHR PPDU) bandwidth information indicates 40 MHz, then the secondary 40/80/160 MHz channel is allowed for secondary channel access. And when the OBSS frame (e.g., non-HT duplicate PPDU, HE PPDU, EHT PPDU, UHR PPDU) bandwidth information indicates 80 MHz, then the secondary 80/160 MHz channel is allowed for secondary channel access. And when the OBSS frame (e.g., non-HT duplicate PPDU, HE PPDU, EHT PPDU, UHR PPDU) bandwidth information indicates 160 MHz, then the secondary 160 MHz channel is allowed for secondary channel access. Finally, when the OBSS frame (e.g., non-HT duplicate PPDU, HE PPDU, EHT PPDU, UHR PPDU) bandwidth information indicates 320 MHz, then secondary channel access is not allowed. At the AP and STA devices 530, 540, the selected secondary channel access can be done until the basic NAV timer set by the OBSS frame becomes 0.

At the STA device 540 which detects the OBSS frame 521 as a Trigger frame (e.g., an MU-RTS Trigger frame), a MAC control response frame (e.g., a CTS frame) can be transmitted considering a PHY CCA and a basic NAV timer value with a bandwidth information of the received OBSS frame that sets the basic NAV timer to a non-zero value. In particular, when a non-AP STA device 540 receives a Trigger frame (e.g., an MU-RTS Trigger frame) indicating an RU allocation of a secondary channel (e.g., S20/S40/S80/S160, any one or more secondary 20 MHz subchannels, etc.) that has not been covered by the bandwidth (e.g., corresponding 20 MHz/40 MHz/80 MHz/160 MHZ) of the OBSS frame, and the basic NAV timer has been set by the OBSS frame to a non-zero value and the basic NAV timer value is not zero, then the non-AP STA device 540 may respond with a MAC control response frame (e.g., CTS frame) on the secondary 20 MHz subchannels allocated by the Trigger frame (e.g., MU-RTS Trigger frame) if the PHY CCA indicates “idle.”

When there is an overlap between any portion of the resource unit (RU) (e.g., S80) allocated by the Trigger frame (e.g., MU-RTS Trigger frame) and the operating bandwidth (e.g., 160 MHZ) of the OBSS frame (e.g., overlapping with S80 of 160 MHZ), then the non-AP STA device 540 does not respond with a MAC control response frame (e.g., a CTS frame). Alternatively, the non-AP STA device 540 may respond with a MAC control response frame (e.g., a CTS frame) on any secondary 20 MHz subchannel(s) that are not overlapped with the bandwidth of the OBSS frame, if any.

In an alternative secondary channel selection scheme, secondary channel access can be performed more conservatively by using the bandwidth information in the OBSS frame to indicate the available secondary channel(s) with a selection which leaves a gap between the OBSS frame bandwidth and the secondary channel options. In this alternative secondary channel selection scheme, the bandwidth information in the OBSS frame indicates the available secondary channel(s) which exclude one level wider bandwidth than the bandwidth of the received OBSS frame. For example, if an OBSS frame indicating 80 MHz BW is received on the primary 20 MHz channel, then the AP and STA devices 530, 540 in the second BSS 502 may access the secondary 160 MHz channel rather than the secondary 80 MHz channel. By creating a gap between the OBSS frame bandwidth and the secondary channel, this reduces the possibility of interference that can otherwise arise between adjacent channels or overlapping channels depending on the channel configuration. For example, when the bandwidth information in the OBSS frame (e.g., non-HT duplicate PPDU, HE PPDU, EHT PPDU, UHR PPDU) indicates 20 MHz, then the secondary 40/80/160 MHz channel is allowed for secondary channel access. And when the OBSS frame (e.g., non-HT duplicate PPDU, HE PPDU, EHT PPDU, UHR PPDU) bandwidth information indicates 40 MHz, then the secondary 80/160 MHz channel is allowed for secondary channel access. And when the OBSS frame (e.g., non-HT duplicate PPDU, HE PPDU, EHT PPDU, UHR PPDU) bandwidth information indicates 80 MHz, then the secondary 160 MHz channel is allowed for secondary channel access. And when the OBSS frame (e.g., non-HT duplicate PPDU, HE PPDU, EHT PPDU, UHR PPDU) bandwidth information indicates 160 MHz or 320 MHz, then secondary channel access is not allowed.

At the AP and STA devices 530, 540 which use the alternative secondary channel selection scheme, the selected secondary channel access can only be performed on a specific secondary channel (e.g., secondary 80 MHz channel, secondary 160 MHz channel). In a first example embodiment, when the bandwidth information in the OBSS frame (e.g., non-HT duplicate PPDU, HE PPDU, EHT PPDU, UHR PPDU) received on the primary 20 Mhz channel indicates a bandwidth equal to or less than 160 MHz, then the AP/STA device 530, 540 may access the secondary 160 MHz channel if the AP device 530's operating bandwidth is 320 MHz. In a second example embodiment, when the bandwidth information in the OBSS frame (e.g., non-HT duplicate PPDU, HE PPDU, EHT PPDU, UHR PPDU) received on the primary 20 Mhz channel indicates a bandwidth equal to or less than 80 MHz, then the AP/STA device 530, 540 may access the secondary 80 MHz channel if the AP device 530's operating bandwidth is 160 MHZ.

As disclosed herein, this secondary channel information that is allowed for secondary channel access can be announce by an AP device 530 through a broadcast management/action frame (e.g., Beacon, Probe Response, etc.) or it can be provided from the AP device 530 to a non-AP STA device 540 by an individual management/action frame (e.g., Association Response, a new action frame, etc.).

In an alternative secondary channel selection scheme, each non-AP STA device 540 may receive a signaling indication in the MAC control frame (e.g., MU-RTS Trigger frame, BSRP Trigger frame, etc.) of whether the non-AP STA device 540 should consider bandwidth information in the OBSS frame to access a secondary channel when transmitting a frame (e.g., CTS frame or trigger-based (TB) PPDU) in response to the MAC control frame. In this alternative secondary channel selection scheme, the MAC control frame 532 in the second BSS 502 may have a predetermined indication bit set to TRUE to indicate that the non-AP STA device 540 is required to consider the bandwidth information of an OBSS frame (e.g., 521, 511) that has set the basic NAV for transmission of an immediate response frame (e.g., CTS frame, BSR frame, etc.) on a secondary channel that the non-AP STA device uses to transmit in response to the MAC control frame 532 (e.g., MU-RTS Trigger frame, BSRP Trigger frame). And if the predetermined indication bit in the MAC control frame 532 is set to FALSE, this indicates that the non-AP STA device 540 is not required to consider the bandwidth information of an OBSS frame that has set the basic NAV for transmission of an immediate response frame (e.g., CTS frame, BSR frame, etc.) on a secondary channel that the non-AP STA device uses to transmit in response to the MAC control frame 532 (e.g., MU-RTS Trigger frame, BSRP Trigger frame, etc.). In other words, if a basic NAV timer at the non-AP STA device 540 is a non-zero value and the predetermined indication bit in the MAC control frame 532 is set to FALSE, an immediate response frame (e.g., CTS frame 542, BSR frame, etc.) transmission is not allowed, regardless of the bandwidth information of the OBSS frame that has set the basic NAV.

In selected embodiments, the TRUE function of the indication bit in the MAC control frame 532 can be implicitly indicated using any suitable technique. For example, the MAC control frame 532 can provide an indication of CTS transmission on a non-primary channel only. Alternatively, the MAC control frame 532 can allocate a resource unit (RU) on a non-primary channel only. Alternatively, a new type of control frame can be provided which indicates that the non-AP STA device 540 is required to consider the bandwidth information of an OBSS frame for secondary channel access purposes.

As will be appreciated, the wireless STA devices, 510, 520, 530, 540 contend for a communication medium using carrier sense multiple access with collision avoidance (CSMA/CA) protocol or another suitable medium access protocol. To control the timing and duration of channel access operations, each wireless STA device maintains respective network allocation vectors (NAVs) that include timers for tracking when another communication device has seized control or “ownership” of a wireless communication medium. For example, when a communication device (e.g., the AP device 530 or non-AP STA device 540) receives a transmitted PHY protocol data unit (PPDU) that conforms to a particular communication protocol (e.g., the IEEE 802.11 Standard, a future version of the IEEE 802.11 Standard, or another suitable communication protocol), the communication device examines TXOP duration information included in the PPDU, where the TXOP duration information indicates a length of time that another communication device has taken ownership of a communication medium. The communication device then uses the TXOP duration information in the PPDU to set a NAV timer, and the NAV timer begins to decrement. When a value of the NAV timer is non-zero, this indicates that the other communication device owns the communication medium and that the communication device therefore should generally refrain from transmitting. On the other hand, when the value of the NAV timer reaches zero, this indicates that the communication medium is not currently owned by another communication device.

To support secondary channel access, each wireless STA device, such as the AP device 530 and/or non-AP STA device 540, may include two dedicated NAV timers which are selectively configured to control the timing and duration of channel access operations by the wireless STA device: an intra-BSS NAV timer and a basic NAV timer. The intra-BSS NAV timer is updated by an intra-BSS PPDU (e.g., a PPDU that is sent within a BSS that includes the wireless STA device). The basic NAV timer is updated by an inter-BSS PPDU (e.g., an OBSS PPDU that is sent from a BSS that does not include the wireless STA device) or a PPDU that cannot be classified as intra-BSS or inter-BSS.

Maintaining two NAV timers is beneficial in dense deployment scenarios in which a wireless STA device requires protection from frames transmitted by STAs within its BSS (e.g., intra-BSS PPDUs), and wants to avoid interference from frames transmitted by wireless STA devices in a neighboring BSS (e.g., inter-BSS PPDUs). For example, in a TXOP initiated by the AP device 530 for an HE TB PPDU transmission with the non-AP STA device 540 that is associated in the second BSS 502, the intra-BSS NAV timer of the non-AP STA device 540 is set by the AP device 530 to prevent the non-AP STA device 540 from contending for the channel. Under existing 802.11 rules, the basic NAV timer of the non-AP STA device 540 is not updated by transmissions from the AP device 530 during the TXOP so that if the basic NAV timer of the non-AP STA device 540 nonzero and the non-AP STA device 540 receives, from the AP device 530, a Trigger frame with the CS Required subfield equal to 1, the non-AP STA device 540 does not respond.

To provide an uplink (UL) multi-user (MU) carrier sense (CS) mechanism, a non-AP STA device does not consider the intra-BSS NAV timer value when determining whether to respond to a Trigger frame sent by the AP device with which the non-AP STA device is associated. However, the non-AP STA does consider the basic NAV timer value when determining whether to respond to a Trigger frame sent by the AP device with which the non-AP STA device is associated. If the CS Required subfield in a Trigger frame is set to “1,” then the non-AP STA device considers the status of the clear channel assessment (CCA) during the SIFS between the Trigger frame and the PPDU sent in response to the Trigger frame. In this case, the non-AP STA device shall sense the medium using energy detect after receiving the PPDU that contains the Trigger frame (i.e., during the SIFS), and it shall perform the energy detect at least in the subchannel that contains the non-AP STA device's UL allocation, where the sensed subchannel consists of one or more 20 MHz channels. The non-AP STA device may transmit the solicited PPDU if the 20 MHz channels containing the RUs allocated in the Trigger frame are considered idle. If the non-AP STA device detects that the 20 MHz channels containing the allocated RUs are not all idle, then the non-AP STA device shall not transmit.

In accordance with the present disclosure, when the basic NAV timer at a non-AP STA device 540 is a non-zero value and receives an inter-BSS PPDU (e.g., OBSS frame 521), the non-AP STA device 540 switches to the secondary channel, there are a number of possible solutions for the non-AP STA device 540 to update the NAV timers upon receiving an OBSS frame from another OBSS on the secondary channel.

In a first solution for updating the basic and intra-BSS NAV timers, the non-AP STA device 540 does not update its basic NAV timer upon receiving an OBSS frame on a secondary channel. Since the secondary channel access is allowed only when the basic NAV timer has a non-zero value, the non-AP STA device 540 which is monitoring the secondary channel does not update the basic NAV timer when it receives an inter-BSS PPDU on the secondary channel. In this solution, the non-AP STA device 540 that receives an inter-BSS PPDU on the secondary channel may switch back to the primary channel (and stop secondary channel access) or may switch to another secondary channel for secondary channel access before the basic NAV timer expires.

In a second solution for updating the basic and intra-BSS NAV timers, the non-AP STA device 540 may update the basic NAV timer, depending on the bandwidth information of an OBSS frame received on the secondary channel. For example, if a non-AP STA device 540 monitors a 20 MHz subchannel of the secondary 160 MHz channel and receives an OBSS frame indicating 80 MHz bandwidth, then the non-AP STA device 540 does not update the basic NAV timer since the bandwidth of the OBSS frame does not cover the primary 20 MHz channel. However, if the non-AP STA device 540 monitors a 20 MHz subchannel of the secondary 160 MHz channel and receives an OBSS frame indicating 320 MHz bandwidth and a TXOP duration value equal to or larger than the current basic NAV timer value, then the non-AP STA device 540 updates the basic NAV timer since the bandwidth of the OBSS frame covers the primary 20 MHz channel. (In this case, the non-AP STA device 540 may switch back to the primary 20 MHz channel since the secondary channel access is not available during the updated basic NAV timer value if a TXOP duration value of the received OBSS frame minus basic NAV timer value is less than a minimum NAV value for secondary channel access). And if a non-AP STA device 540 monitors a 20 MHz subchannel of the secondary channel where the non-AP STA 540 does the EDCA backoff and receives an OBSS frame with unknown bandwidth information, then the non-AP STA device 540 may update the basic NAV timer if the TXOP duration information indicated in the received OBSS frame is equal to or larger than the current basic NAV timer value and may switch back to the primary 20 MHz channel. A specific 20 MHz subchannel of the secondary channel can be defined as a secondary backoff channel for secondary channel access.

In a third solution for updating the basic and intra-BSS NAV timers, the non-AP STA device 540 may update the basic NAV timer and switch back to the primary 20 MHZ channel. For example, if the non-AP STA device 540 monitors a 20 MHz subchannel of the secondary channel and receives an OBSS frame 521 that updates a basic NAV timer (e.g., a value of the TXOP duration in the received OBSS frame is larger than the basic NAV timer value), then the non-AP STA device 540 may update the basic NAV timer and may switch back to the primary 20 MHz channel if a TXOP duration value of the received OBSS frame minus the current basic NAV timer value is less than a minimum basic NAV value for secondary channel access (described hereinbelow).

In accordance with the present disclosure, the non-AP STA device may update the intra-BSS NAV timer when receiving an intra-BSS PPDU on a secondary channel, regardless of the bandwidth information of the received frame, during the secondary channel access.

In an alternative secondary channel selection scheme, each AP STA device 530 may send a MAC control or trigger frame (e.g., MU-RTS Trigger frame) to the non-AP STA device 540 which includes a secondary channel signaling indication (e.g., Secondary Channel Indication field) which identifies the secondary channel that the MAC control frame is transmitted on. In selected embodiments, the secondary channel signaling indication can indicate at least one of the following: the Primary channel, the Secondary 20 MHz channel, the Secondary 40 MHz channel, the Secondary 80 MHz channel, and/or the Secondary 160 MHZ channel. In addition, the uplink (UL) bandwidth (BW) subfield in the Common Info field indicates the bandwidth of the PPDU carrying the Trigger frame on the secondary channel which is identified in the secondary channel signaling indication. In this example, if the UL BW is set to a value indicating 40 MHz, and the Secondary Channel Indication field is set to a value indicating 160 MHz, then the MAC control or trigger frame 532 is transmitted by the AP STA device 530 on the 40 MHz subchannel of the secondary 160 MHz channel.

In an alternative secondary channel selection scheme, each wireless STA device in a BSS may perform a secondary channel access only when the basic NAV timer value (e.g., OBSS TXOP) set by a received OBSS PPDU is equal to or larger than a minimum specified value of the OBSS TXOP for secondary channel access. The reason for requiring a minimum or threshold basic NAV timer value for any secondary channel access is that, without a minimum specified value, an AP STA device and a non-AP STA device may fail to successfully exchange frames on a secondary channel access that is used in response to receiving an OBSS frame with a TXOP duration value that does not provide sufficient time for the frame exchange on the secondary channel. Another problem that can arise without a minimum or threshold basic NAV timer value is the unnecessary power consumption by the non-AP STA device which is not on the same channel as the AP STA device (e.g., primary channel or secondary channel) without any rule to switch back and forth to the secondary channel and to the primary channel. For example, when an AP STA device 530 and a non-AP STA device 540 receive an OBSS frame 521 with a TXOP duration value set to a several tens of micro seconds (e.g., 64 us, 92 us, etc.), the AP STA device 530 does not perform the secondary channel access with the non-AP STA device 540 due to its insufficient time duration for frame exchanges, but the non-AP STA device 540 may nonetheless switch to the secondary channel to monitor the secondary channel during the OBSS TXOP or vice-versa, thereby causing unnecessary power consumption.

One solution for avoiding frame exchange failures and/or unnecessary power consumption is to have the AP STA device 530 provide or specify, to each non-AP STA device 540 that supports secondary channel access, a minimum specified value of the OBSS TXOP duration (e.g., minimum basic NAV timer value) for secondary channel access. The minimum basic NAV timer value can be provided or specified by the AP STA device 520 using any suitable signaling mechanism, such as a management frame, an action frame, or a MAC control frame. For example, the minimum basic NAV timer value can be included in the UHR Capabilities element or in the UHR Operation element. In addition or in the alternative, the minimum basic NAV timer value can be included in the Beacon frame, the Probe Response frame, and the Association Response frame. In addition or in the alternative, the minimum basic NAV timer value can be defined with multiple values, such as MinOBSSTXOP1, MinOBSSTXOP2 and MinOBSSTXOP3 for multiple secondary channel access attempts if multiple secondary channel sets are defined. For example, a wireless STA device may access a first secondary channel if the basic NAV timer value is larger than a specified value of MinOBSSTXOP1, and the wireless STA device may access a second secondary channel if the first secondary channel is busy and if the basic NAV timer value is larger than a specified value of MinOBSSTXOP2, etc.

In other embodiments, the minimum basic NAV timer value can be larger than at least the time delay information for switching back and forth between the primary channel and the secondary channel to avoid medium synchronization error before the OBSS TXOP ends.

In certain wireless STA signaling scenarios, there may be situations where secondary channel access may need to be disallowed when receiving an OBSS frame. For example, there are multi-AP coordinated transmission/scheduling scenarios where a related control frame or action frame is exchanged among multiple AP devices. To a non-AP STA device that supports secondary channel access, a multi-AP related control frame (or action frame) can be received as an OBSS frame (e.g., inter-BSS PPDU) which causes the non-AP STA device to switch to a secondary channel during the multi-AP coordinated TXOP. If this switch to a secondary channel happens at the non-AP STA device, a shared AP that is associated with the non-AP STA device is not able to schedule DL/UL transmission to the non-AP STA device during the multi-AP coordinated TXOP.

One solution for preventing the non-AP STA device from switching to a secondary channel during the multi-AP coordinated TXOP operation is to disallow secondary channel access at a non-AP STA device when receiving an OBSS frame, such as a multi-AP related control frame (though other OBSS frames may include the secondary channel access allowance indication). To this end, a multi-AP related control frame that is generated by an OBSS AP device 520 may be configured to include an indication for secondary channel access allowance, such as in the MAC information (e.g., MAC control header, MAC control frame, etc.) and/or in a PHY header of an Ultra High Reliability (UHR) PPDU. When the indication in the OBSS frame is set to TRUE, this indicates that a wireless STA device (e.g., non-AP STA device 540) receiving the OBSS frame is allowed to perform secondary channel access during the TXOP indicated in the OBSS frame. However, when the indication in the OBSS frame is set to FALSE, this indicates that a wireless STA device (e.g., non-AP STA device 540) receiving the OBSS frame is not allowed to perform secondary channel access during the TXOP indicated in the OBSS frame. In selected embodiments, the indication can be implicitly indicated as FALSE, such as by using a specified type of MAC control frame (e.g., M-AP Control frame, etc.). For example, if a non-AP STA device 540 receives the MAC control frame 521 as a M-AP Control frame, the non-AP STA device 540 is configured to prevent or disallow secondary channel access during the TXOP indicated in the M-AP Control frame.

At the receiving end, a non-AP STA device 540 that receives an OBSS frame with the indication set to TRUE may perform secondary channel access (e.g., switching to and monitoring the secondary channel) during the TXOP indicated in the frame. However, a non-AP STA device 540 that receives an OBSS frame with the indication set to FALSE does not perform secondary channel access during the TXOP indicated in the frame and remain on the primary channel.

In other selected embodiments, a default operation mode can be defined as the secondary channel access to be enabled, which means that the AP and the non-AP STA perform the secondary channel access during the OBSS TXOP if they receive an OBSS frame (with the TXOP duration information and the BW information) without an explicit secondary channel allowance indication.

By now it should be appreciated that there has been provided an apparatus, method, and system for accessing a secondary channel at a wireless station (STA) device in response to an inter-BSS PPDU in accordance with a predetermined wireless protocol (e.g., the IEEE 802.11 protocol). In the disclosed methodology, the wireless STA device receives an inter-BSS PPDU which identifies a transmission channel bandwidth for the inter-BSS PPDU and transmission opportunity (TXOP) duration. In selected embodiments, the inter-BSS PPDU is selected from a group consisting of an HE PPDU, an EHT PPDU, an UHR PPDU, a trigger frame, an RTS frame in a non-HT PPDU, a CTS frame in a non-HT PPDU, an ACK frame in a non-HT PPDU, and a BA frame in a non-HT PPDU. In addition, the wireless STA device accesses a secondary channel which excludes the transmission channel bandwidth identified by the inter-BSS PPDU and a primary 20 MHz channel for the wireless STA device from a basic service set (BSS) operating bandwidth associated with the wireless STA device. In selected embodiments, the wireless STA device accesses the secondary channel by decoding at least a portion of the inter-BSS PPDU (e.g., a PHY or MAC header portion) to extract the transmission channel bandwidth for the inter-BSS PPDU and the transmission opportunity (TXOP) duration, identifying the secondary channel by using at least the transmission channel bandwidth for the inter-BSS PPDU to select the secondary channel from a group of secondary channels that are adjacent to the transmission channel bandwidth, and then switching to the secondary channel for exchanging one or more frames during the TXOP duration. In other selected embodiments, the wireless STA device accesses the secondary channel by decoding at least a portion of the inter-BSS PPDU to extract the transmission channel bandwidth for the inter-BSS PPDU and the transmission opportunity (TXOP) duration, identifying the secondary channel by using at least the transmission channel bandwidth for the inter-BSS PPDU to select the secondary channel from a group of secondary channels that are separated from the transmission channel bandwidth by a frequency gap equal to the transmission channel bandwidth, and then switching to the secondary channel for exchanging one or more frames during the TXOP duration. In addition, the wireless STA device transmits and receives one or more frames on the secondary channel during the TXOP duration without using the primary 20 MHz channel for the wireless STA device. In addition, the wireless STA device switches back to the primary 20 MHz channel before the TXOP duration ends. In selected embodiments, the wireless STA device is a wireless access point STA device. In other selected embodiments, the wireless STA device is a wireless non-access point STA device. In other selected embodiments, the wireless access point STA device and/or the wireless non-access point STA device includes a basic network allocation vector (NAV) timer. In such embodiments, a wireless non-access point STA device having a basic NAV timer may receive a second inter-BSS PPDU on the secondary channel which identifies a second transmission channel bandwidth for the second inter-BSS PPDU and a second transmission opportunity (TXOP) duration, and may update the basic NAV timer based on the second transmission channel bandwidth and the second TXOP duration that are identified in the second inter-BSS PPDU. In selected embodiments, the secondary channel is accessed in response to the wireless STA device receiving a MAC control frame which includes an indication bit that expressly or implicitly signals that the wireless STA device is required to consider the transmission channel bandwidth when identifying the secondary channel. In other selected embodiments, the secondary channel is accessed in response to the wireless STA device receiving a trigger frame which includes a secondary channel indication subfield that identifies which secondary channel the trigger frame is transmitted on. In other embodiments, the wireless STA device receives an inter-BSS PPDU with the TXOP duration larger than a predetermined value, where in the secondary channel is accessed based on the TXOP duration. In other selected embodiments, an indication bit in the PHY or MAC header portion of the inter-BSS PPDU expressly or implicitly signals that the wireless STA device is allowed to perform secondary channel access.

In yet another form, there is provided a wireless STA device, method, and system for exchanging one or more frames in a wireless area network in accordance with IEEE 802.11 protocol. The disclosed wireless STA device includes a transceiver arranged to exchange one or more frames with one or more wireless devices, a processor, and a memory storing instructions. When executed by the processor, the instructions cause the wireless STA device to receive an inter-BSS PPDU which identifies a transmission channel bandwidth for the inter-BSS PPDU and transmission opportunity (TXOP) duration. In addition, the execution of the instructions at the processor causes the wireless STA device to access a secondary channel which excludes the transmission channel bandwidth identified by the inter-BSS PPDU and a primary 20 MHz channel for the wireless STA device from a basic service set (BSS) operating bandwidth associated with the wireless STA device. In addition, the execution of the instructions at the processor causes the wireless STA device to transmit and receive one or more frames on the secondary channel during the TXOP duration without using the primary 20 MHz channel for the wireless STA device. In addition, the execution of the instructions at the processor causes the wireless STA device to switch back to the primary 20 MHz channel before the TXOP duration ends. In selected embodiments, the wireless STA device also includes a basic network allocation vector (NAV) timer. In such embodiments, the execution of the instructions by the processor causes the wireless STA device to receive a second inter-BSS PPDU on the secondary channel which identifies a second transmission channel bandwidth for the second inter-BSS PPDU and a second transmission opportunity (TXOP) duration, and to update the basic NAV timer based on the second transmission channel bandwidth and the second TXOP duration that are identified in the second inter-BSS PPDU. In selected embodiments, the execution of the instructions at the processor causes the wireless STA device to access the secondary channel by decoding at least a portion of the inter-BSS PPDU (e.g., a PHY or MAC header portion) to extract the transmission channel bandwidth for the inter-BSS PPDU and the transmission opportunity (TXOP) duration; identifying the secondary channel by using at least the transmission channel bandwidth for the inter-BSS PPDU to select the secondary channel from a group of secondary channels that are adjacent to the transmission channel bandwidth; and switching to the secondary channel for exchanging one or more frames during the TXOP duration. In other selected embodiments, the execution of the instructions at the processor causes the wireless STA device to access the secondary channel by decoding at least a portion of the inter-BSS PPDU to extract the transmission channel bandwidth for the inter-BSS PPDU and the transmission opportunity (TXOP) duration; identifying the secondary channel by using at least the transmission channel bandwidth for the inter-BSS PPDU to select the secondary channel from a group of secondary channels that are separated from the transmission channel bandwidth by a frequency gap equal to the transmission channel bandwidth; and switching to the secondary channel for exchanging one or more frames during the TXOP duration. In other selected embodiments, the execution of the instructions at the processor causes the wireless STA device to access the secondary channel in response to receiving a MAC control frame comprising an indication bit that expressly or implicitly signals that the wireless STA device is required to consider the transmission channel bandwidth when identifying the secondary channel. In other selected embodiments, the execution of the instructions at the processor causes the wireless STA device to access the secondary channel in response to receiving a trigger frame comprising a secondary channel indication subfield that identifies which secondary channel the trigger frame is transmitted on. In other selected embodiments, an indication bit in the PHY or MAC header portion of the inter-BSS PPDU that expressly or implicitly signals that the wireless STA device is allowed to perform secondary channel access.

The present disclosure is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements may be used in order to use any OBSS PPDU sent from a first BSS (e.g., HE/EHT/UHR PPDU, RTS/CTS/Ack/BA in a non-HT PPDU, Trigger frame, etc.) that is received at a wireless STA device in a second, neighboring BSS to decode or extract the OBSS TXOP duration and BW information of the OBSS PPDU which is then used to identify a secondary channel for use by the wireless STA devices in the second, neighboring BSS at the same time for frame exchanges during the OBSS TXOP. For example, if AP and STA devices in the second BSS detect an OBSS PPDU (e.g., HE/EHT/UHR PPDU) from the first BSS and decode its PHY header, then the AP and STA devices in the second BSS can obtain the OBSS TXOP duration and BW information of the OBSS PPDU from the HE/EHT/UHR SIG field in the PHY header, and can then can switch to the secondary channel at the same time for frame exchanges during the OBSS TXOP. Similarly, AP and STA devices in the second BSS which receive an OBSS PPDU (e.g., RTS/CTS/Ack/BA in a non-HT PPDU) from the first BSS can obtain the OBSS TXOP duration from the Duration field in the MAC header and can also obtain the the BW information from the SERVICE field of the non-HT PPDU. Similarly, if AP and STA devices in the second BSS that receive an OBSS PPDU (e.g., Trigger frame) from the first BSS can obtain the OBSS TXOP duration from the Duration field in the MAC header, and can also obtain the BW information from the UL BW subfield of the Common Info field in the Trigger frame. Then, the AP and STA devices in the second BSS can switch to the secondary channel at the same time for frame exchanges during the OBSS TXOP. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a wireless station (STA) device, an inter-basic service set (BSS) Physical layer Protocol Data Unit (PPDU) which identifies a transmission channel bandwidth for the inter-BSS PPDU and transmission opportunity (TXOP) duration;
accessing, by the wireless STA device, a secondary channel which excludes the transmission channel bandwidth identified by the inter-BSS PPDU and a primary 20 MHz channel for the wireless STA device from a basic service set (BSS) operating bandwidth associated with the wireless STA device;
transmitting and receiving, by the wireless STA device, one or more frames on the secondary channel during the TXOP duration without using the primary 20 MHz channel for the wireless STA device; and
switching, by the wireless STA device, back to the primary 20 MHz channel before the TXOP duration ends.

2. The method of claim 1, where the wireless STA device comprises a wireless access point STA device.

3. The method of claim 1, where the wireless STA device comprises a wireless non-access point STA device.

4. The method of claim 3, where the wireless non-access point STA device comprises a basic network allocation vector (NAV) timer.

5. The method of claim 4, further comprising:
receiving, by the wireless non-access point STA device, a second inter-BSS PPDU on the secondary channel which identifies a second transmission channel bandwidth for the second inter-BSS PPDU and a second transmission opportunity (TXOP) duration, and
updating, by the wireless non-access point STA device, the basic NAV timer based on the second transmission channel bandwidth and the second TXOP duration that are identified in the second inter-BSS PPDU.

6. The method of claim 1, where the inter-BSS PPDU is selected from a group consisting of a high-efficiency (HE) PPDU, an extremely high-throughput (EHT) PPDU, an ultra high reliability (UHR) PPDU, a trigger frame, a request-to-send (RTS) frame in a non-high-throughput (HT) PPDU, a clear-to-send (CTS) frame in a non-HT PPDU, an acknowledgement (ACK) frame in a non-HT PPDU, and a block acknowledgement (BA) frame in a non-HT PPDU.

7. The method of claim 1, where accessing the secondary channel comprises:
decoding, by the wireless STA device, at least a portion of the inter-BSS PPDU to extract the transmission channel bandwidth for the inter-BSS PPDU and the transmission opportunity (TXOP) duration;
identifying, by the wireless STA device, the secondary channel by using at least the transmission channel bandwidth for the inter-BSS PPDU to select the secondary channel from a group of secondary channels that are adjacent to the transmission channel bandwidth; and
switching, by the wireless STA device, to the secondary channel for exchanging one or more frames during the TXOP duration.

8. The method of claim 1, where accessing the secondary channel comprises:
decoding, by the wireless STA device, at least a portion of the inter-BSS PPDU to extract the transmission channel bandwidth for the inter-BSS PPDU and the transmission opportunity (TXOP) duration;
identifying, by the wireless STA device, the secondary channel by using at least the transmission channel bandwidth for the inter-BSS PPDU to select the secondary channel from a group of secondary channels that are separated from the transmission channel bandwidth by a frequency gap equal to the transmission channel bandwidth; and
switching, by the wireless STA device, to the secondary channel for exchanging one or more frames during the TXOP duration.

9. The method of claim 1, further comprising accessing the secondary channel in response to receiving, at the wireless STA device, a MAC control frame comprising an indication bit that expressly or implicitly signals that the wireless STA device is required to consider the transmission channel bandwidth when identifying the secondary channel.

10. The method of claim 1, further comprising accessing the secondary channel in response to receiving, at the wireless STA device, a trigger frame comprising a secondary channel indication subfield that identifies which secondary channel the trigger frame is transmitted on.

11. The method of claim 1, further comprising receiving, at the wireless STA device, an inter-BSS PPDU with the TXOP duration larger than a predetermined value, wherein the the secondary channel is accessed based on the TXOP duration.

12. The method of claim 1, where an indication bit in the PHY or MAC header portion of the inter-BSS PPDU that expressly or implicitly signals that the wireless STA device is allowed to perform secondary channel access.

13. A wireless station (STA) device for transmitting and receiving one or more frames in accordance with Institute of Electrical and Electronics Engineers 802.11 protocol, comprising:
a transceiver arranged to exchange one or more frames with one or more wireless devices;
a processor; and
a memory storing instructions that, when executed by the processor, cause the wireless STA device to:
receive an inter-BSS PPDU which identifies a transmission channel bandwidth for the inter-BSS PPDU and transmission opportunity (TXOP) duration;
access a secondary channel which excludes the transmission channel bandwidth identified by the inter-BSS PPDU and a primary 20 MHz channel for the wireless STA device from a basic service set (BSS) operating bandwidth associated with the wireless STA device;
transmit and receive one or more frames on the secondary channel during the TXOP duration without using the primary 20 MHz channel for the wireless STA device; and
switch back to the primary 20 MHz channel before the TXOP duration ends.

14. The wireless STA device of claim 13, further comprising a basic network allocation vector (NAV) timer.

15. The wireless STA device of claim 14, where the instructions stored in memory, when executed by the processor, cause the wireless STA device to:
receive a second inter-BSS PPDU on the secondary channel which identifies a second transmission channel bandwidth for the second inter-BSS PPDU and a second transmission opportunity (TXOP) duration, and
update the basic NAV timer based on the second transmission channel bandwidth and the second TXOP duration that are identified in the second inter-BSS PPDU.

16. The wireless STA device of claim 13, where the instructions stored in memory, when executed by the processor, cause the wireless STA device to access the secondary channel by:
decoding at least a portion of the inter-BSS PPDU to extract the transmission channel bandwidth for the inter-BSS PPDU and the transmission opportunity (TXOP) duration;
identifying the secondary channel by using at least the transmission channel bandwidth for the inter-BSS PPDU to select the secondary channel from a group of secondary channels that are adjacent to the transmission channel bandwidth; and
switching to the secondary channel for exchanging one or more frames during the TXOP duration.

17. The wireless STA device of claim 13, where the instructions stored in memory, when executed by the processor, cause the wireless STA device to access the secondary channel by:
decoding at least a portion of the inter-BSS PPDU to extract the transmission channel bandwidth for the inter-BSS PPDU and the transmission opportunity (TXOP) duration;
identifying the secondary channel by using at least the transmission channel bandwidth for the inter-BSS PPDU to select the secondary channel from a group of secondary channels that are separated from the transmission channel bandwidth by a frequency gap equal to the transmission channel bandwidth; and
switching to the secondary channel for exchanging one or more frames during the TXOP duration.

18. The wireless STA device of claim 13, where the instructions stored in memory, when executed by the processor, cause the wireless STA device to access the secondary channel in response to receiving a MAC control frame comprising an indication bit that expressly or implicitly signals that the wireless STA device is required to consider the transmission channel bandwidth when identifying the secondary channel.

19. The wireless STA device of claim 13, where the instructions stored in memory, when executed by the processor, cause the wireless STA device to access the secondary channel in response to receiving a trigger frame comprising a secondary channel indication subfield that identifies which secondary channel the trigger frame is transmitted on.

20. The wireless STA device of claim 13, where an indication bit in the PHY or MAC header portion of the inter-BSS PPDU that expressly or implicitly signals that the wireless STA device is allowed to perform secondary channel access.
